(19) United States
(12) Patent Application Publication
(10) Pub. No.: US 2004/0058705 A1
(43) Pub. Date: Mar. 25, 2004

(54) Secure point-of-sale cellular telephone docking module system

(76) Inventors: Russell Morgan, Newport Beach, CA (US); Adam Hemsley, Amsterdam, NY (US)

Correspondence Address: Jon E. Hokanson, Small Larkin, LLP, 10940 Wilshire Blvd., 18th Floor, Los Angeles, CA, 90024, US

(21) Appl. No.: 10/027,485

(22) Filed: Dec. 21, 2001

(51) Int. Cl. H04B 7/15

(52) U.S. Cl. 455/556.1; 455/550.1; 455/575.1; 455/90.3; 455/11.1

(57) ABSTRACT

The present invention describes a docking module for a cellular telephone which allows the cellular telephone and docking module to function as a secure point-of-sale system to accept payment via credit card, debit card, ATM card, stored value (Gift) card, phone card, as either magnetic swipe cards or IC cards, for sales or service transactions, as well as activate or recharge phone cards, activate or recharge stored value (Gift) cards, and activate or recharge IC cards. The secure point-of-sale system will also perform check validation sequences that will allow checks to be safely accepted for sales and service transactions. The docking module includes a docking module control assembly with a microprocessor that controls a magnetic credit card reader, an IC card reader/writer, a thermal docket printer, a multifunction security access module (SAM) and battery. The docking module control assembly mates with an existing cellular telephone and battery, and allows the cellular telephone and docking module combination to become a fully functional mobile secure point-of-sale system. The docking module control assembly, when activated, will cause the cellular telephone to dial a registration computer for approval utilizing the local cellular network and countrywide public switching telecommunications network (PSTN). The registration computer will validate the transaction with the appropriate bank or card issuing body, and a response will be sent via the return path advising whether the transaction has been accepted or denied. The resultant mobile secure point-of-sale system will now meet the security requirements of banks and financial institutions worldwide. By disconnecting the cellular telephone from the docking module, the cellular telephone reverts to its normal functions.

### BACKGROUND OF THE INVENTION

There are a number of disparate developments that have led to the development of this product.

1. There has been a great proliferation of cellular phones into the general populace.

2. There has been an improvement of the cellular coverage of the populated areas of the USA.

3. There exists a large body of mobile professional and trades people who would like the ability of securely being able to accept credit card, debit card and check transactions for their services as well as a growing need, both by perspective customers and hopeful resellers at swap meets, trade fairs, etc. to be able to securely accept credit card and check transactions for their goods or services being offered for sale.

4. Technology has advanced to the stage that makes the embodiment of this patent application an economic reality.

5. The cost of a stand-alone radio POS terminal is still in excess of $1,000, which places it outside the capability of most people to amortize the cost of such a unit.

6. Other patents have been issued that convert existing cell phones into a credit card based “public Telephone” for use in limousines and airliners. None of these address the issue of utilizing a cellular phone, without modification, to make a secure point-of-sale terminal for the sale of goods or services.

The present invention converts a standard cellular telephone into a secure point-of-sale system, that includes mechanical structures enabling entry of magnetic strip credit card or IC card (Smart Card) information, and has a location for an interface connector to mate with the cellular telephone auxiliary connector that enables the circuitry of a standard cellular telephone to interface with the docking module control assembly to then interface to a magnetic credit card reader, a magnetic ink character reader (MICR reader assembly), a conventional integrated circuit (IC) card reader, a thermal docket printer unit and the multifunction security access module (SAM) contained therein. A battery and cable assembly provide power for the docking module control assembly and associated electronics, whilst an external power connector provides the facility to externally power the unit and recharge the battery.

This new entity of the cellular telephone and docking module then becomes the secure point-of-sale system that accepts input from a magnetic stripe card-type device such as a credit card, debit card, ATM card, stored value (Gift) card, phone card or IC card. It is also capable of activating phone cards and stored value (Gift) cards, as well as recharging phone cards and stored value (Gift) cards.

U.S. Pat. No. 4,776,003 to Harris (herein Harris) discloses a cellular phone coupled to a station processor that is coupled to a credit card reader. The station processor initially verifies the credit card information, i.e., expiry date, etc. The station processor has a visual display inviting the user to (a) swipe the card through the reader, (b) display “Checking Card” and (c) display “Lift Handset and Dial” or “Sorry.” The visual display also shows “Hello.” From this point on, the cellular phone acts as a normal pay phone in all respects.

U.S. Pat. No. 4,831,647 to D'Avello (herein D'Avello) discloses a method and apparatus for communicating credit card information read at a mobile radiotelephone unit, where the data read from the credit card is placed in a variable length error protected format and transmitted from the mobile radiotelephone unit to an authorizing payment system for validation and control of the subsequent telephone call.

U.S. Pat. No. 4,845,470 to Tokuyama (herein Tokuyama) discloses a radiotelephone system adapted to read a credit card and communicating the credit card information read as well as a dial number dialed by a keypad at a mobile radiotelephone unit, by means of a modem and a transmitter/receiver, and in the case where the data read from the credit card information is valid, establishing a voice channel for the duration of the call.

U.S. Pat. No. 4,860,336 to D'Avello (herein D'Avello) discloses a cellular phone coupled to a credit card reader. A processor in the phone initially verifies the credit card information, i.e., expiration date etc. The phone has lighted indicators informing the user (a) to swipe the card through the reader, (b) to “Please wait,” and (c) “Sorry.” A visual display also shows “Hello.” The processor determines if the new card data matches the last card validated by the unit. If so, the processor permits the user to call from the cellular phone. If the card data does not match, the cellular phone dials up a registration computer. A two-way communications link is established such that the registration computer validates the card, by checking the computer's database, and then sends a validation code to the cellular phone. The registration computer, after validation or rejection of the card, disconnects the cellular telephone link with the phone. The cellular phone then permits the user to place as many phone calls as necessary. The cellular phone, before or after validation, permits 911 calls. The phone has an electronic lockout which prohibits calls if a call timer limit is exceeded, if the car door is open or after a power-up of the phone (unless the card matches the last validated card). The registration computer can program the phone.

U.S. Pat. No. 4,860,341 to D'Avello (herein D'Avello) discloses a mobile radiotelephone call synchronization system utilizing a credit card for payment of calls. Call access is denied until a user swipes his/her credit card and the credit card information has been communicated by the mobile radiotelephone unit to a registration computer for approval. The phone has lighted indicators informing the user (a) to swipe the card through the reader, (b) to “Pls wait,” (c) to “Lift Rcvr,” and (c) “Sorry.” A visual display also shows “Hello.” The system determines if the new card data matches the last card validated by the unit. If so, the processor permits the user to call from the cellular phone. If the card data does not match, the mobile radiotelephone dials up a registration computer. A two-way communications link is established such that the registration computer validates the card, by checking the computer's database, and then sends a validation code to the mobile radiotelephone. The registration computer, after validation or rejection of the card, disconnects the mobile radiotelephone link with the phone. The mobile radiotelephone then permits the user to place as many phone calls as necessary.

U.S. Pat. No. 4,965,821, to Bishop discloses a cellular phone installed in a rental car. The cellular phone has a credit card reader. The phone detects an open car door. The user selects a rental car and the phone issues visual indicators prompting the customer to insert his or her credit card. The phone initially validates the card, i.e., checks the expiration date. The phone also issues voice prompts to instruct the user regarding the steps to rent the car. The phone communicates with another computer via a cellular network. This computer validates the card and determines whether the car selected by the user conforms to a corporate profile stored in the computer. For example, is the user permitted to rent a luxury car, or has his or her company limited rentals to compact cars? After validation, the computer communicates with the processor in the phone and validates the transaction. The user drives the car to a booth at the exit of the lot and receives and signs a car rental agreement. This agreement is also electronically stored in the phone.

U.S. Pat. No. 5,729,591 to Bailey (herein Bailey) discloses a modification to an existing cellular telephone to incorporate a credit card reader and interface unit. The credit card reader accepts input from both credit and debit cards. The modified cellular telephone calls a processing center, which processes the credit card information and then forwards the call to the final receiver. The cost of the call is billed to the credit card holder.

U.S. Pat. No. 5,850,599 to Seiderman (herein Seiderman) discloses a cellular phone coupled to a credit card reader and control unit. A processor in the control unit initially verifies the credit card information, i.e., expiration date etc., and checks the expiration date against a real time clock in the control unit. If the control unit determines that the card is not valid, or is past the expiration date, it issues a voice response advising, “Please swipe another card,” and three lighted arrows continue to flash to indicate to the user where to swipe the card. When the credit card is accepted by the control unit, the three arrows stop flashing and become permanently lit, a voice prompt then prompts the user to dial the destination telephone number and accepts the destination phone number typed in by the user. The control unit immediately dials an 800 number (a call placement number) to a telecommunications network, which includes a local cellular carrier and an Inter Exchange Carrier (IXC) and passes the credit card details, cellular telephone ID and destination phone number typed in by the user to the IXC. The IXC validates the credit card and proceeds to bill the credit card user for the subsequent call. The IXC then connects the cellular telephone with the destination telephone. The IXC places the credit card information in memory and holds this information in the event that the user makes additional calls.

U.S. Pat. No. 5,886,333 to Miyake (herein Miyake) discloses various methodologies for transferring information from a mini IC card to a format that can be easily used in a normal swipe card reader, as a method of encouraging the broad acceptance of mini IC cards into the retail arena.

U.S. Pat. No. 6,029,892 to Miyake (herein Miyake) discloses various methodologies for transferring information from a mini IC card to a format that can be easily used in a normal swipe card reader, as a method of encouraging the broad acceptance of mini IC cards into the retail arena.

### SUMMARY OF THE INVENTION

It is an object of this invention to provide an improved vehicle for the acceptance of ATM card, credit card, debit card, IC card, phone card, stored value (Gift) card, or checks to be accepted as payment for goods or services in any application where the use of a normal public switched telecommunications network (PSTN) point-of-sale terminal or RAM radio point-of-sale terminal is neither practical nor cost effective. It is also an object of the present invention to allow stored value cards like stored value (Gift) cards and phone cards to be activated or recharged with funds, and to allow IC card to IC card fund transfers to be conducted.

For a retail sale, the customer inserts their IC card into the IC card reader of the docking module, or the merchant swipes the magnetic strip card through the magnetic credit card reader, or the merchant swipes a check through the check reader.

For a credit/debit card transaction—the microprocessor on the docking module control assembly checks the credit card number and expiration date on track two of the card. The expiration date is checked against the network date of the attached cellular telephone. The microprocessor on the docking module control assembly conducts a Luhn validation of the card number to determine if the card may have been altered or forged. These checks are important to be able to reject obviously invalid or out-of-date cards prior to putting the retailer through the cost of an unnecessary cellular call.

If the microprocessor on the docking module control assembly determines that the expiration date has expired or the card is not valid, it prints out on the thermal docket printer a brief report advising that the card has expired or is invalid.

If the microprocessor on the docking module control assembly determines that the card is valid and is not expired, then the microprocessor on the docking module control assembly displays a message on the attached cellular phone's screen advising the retailer to key in the sale amount. The microprocessor on the docking module control assembly then prompts the retailer to enter the standard options of Credit/Debit (Savings or Check) for the source of funds for the transaction. The microprocessor on the docking module control assembly then prompts the customer for their PIN number.

Upon acceptance of the PIN number from the customer, the microprocessor on the docking module control assembly, utilizing the incorporated multifunction security access module (SAM) to encrypt the transaction (credit/debit card number, PIN, etc) prior to invoking a dialing routine with the attached cellular telephone. The cellular telephone dials the pre-configured number of the registration computer. The registration computer will validate the transaction with the appropriate bank or card issuing body, and a response is returned to the microprocessor on the docking module control assembly, via the attached cellular telephone, that either accepts or rejects the transaction.

If the transaction is declined, the microprocessor on the docking module control assembly instructs the thermal docket printer to print a ‘Transaction Rejected’ slip on the thermal docket printer, and display a ‘Transaction Rejected’ message on the screen of the attached cellular telephone.

If the transaction is accepted, the microprocessor on the docking module control assembly instructs the thermal docket printer to print a detailed sales slip for the customer to sign, and display a ‘Transaction Approved’ message on the screen of the attached cellular telephone.

For a check transaction—the microprocessor on the docking module control assembly reads the bank, account details and check number of the check. The microprocessor on the docking module control assembly conducts a validation of the check details to determine if the information read was valid. These checks are important to be able to reject obviously invalid or illegible checks prior to putting the retailer through the cost of an unnecessary cellular call.

If the microprocessor on the docking module control assembly determines that the check details are invalid or illegible, it displays a message advising the retailer to manually enter the check details.

If the microprocessor on the docking module control assembly determines that the information from the check is valid or that the information typed in by the retailer is valid, then the microprocessor on the docking module control assembly displays a message on the attached cellular telephone's screen advising the retailer to key in the check amount.

Upon acceptance of the check amount typed in by the retailer, the microprocessor on the docking module control assembly, utilizing the incorporated multifunction security access module (SAM) to encrypt the transaction (bank, account number, amount, etc) prior to invoking a dialing routine with the attached cellular telephone. The cellular telephone dials the pre-configured number of the registration computer. The registration computer will validate the check with the appropriate check validation body, and a response is returned to the microprocessor on the docking module control assembly, via the attached cellular telephone, that either accepts or rejects the transaction.

If the transaction is declined, the microprocessor on the docking module control assembly instructs the thermal document printer to print a ‘Transaction Rejected’ slip on the thermal docket printer, and display a ‘Transaction Rejected’ message on the screen of the attached cellular telephone.

If the transaction is accepted, the microprocessor on the docking module control assembly instructs the thermal docket printer to print a detailed sales slip for the customer, and display a ‘Transaction Approved’ message on the screen of the attached cellular telephone.

For the activation of a stored value card, gift card or phone card—the microprocessor on the docking module control assembly checks the card number and expiration date (if applicable) on track two of the card. The expiration date is checked against the network date of the attached cellular telephone. The microprocessor on the docking module control assembly conducts a Luhn validation of the card number to determine if the card may have been altered or forged. These checks are important to be able to reject obviously invalid or out-of-date cards prior to putting the retailer through the cost of an unnecessary cellular call.

If the microprocessor on the docking module control assembly determines that the expiration date has expired or the card is not valid, it prints out on the thermal docket printer a brief report advising that the card has expired or is invalid.

If the microprocessor on the docking module control assembly determines that the card is valid and is not expired, then the microprocessor on the docking module control assembly displays a message on the attached cellular telephone's screen advising the retailer to key in the amount to be added to the value of this card. The microprocessor on the docking module control assembly then prompts the retailer for their enabling PIN number.

Upon acceptance of the PIN number from the retailer, the microprocessor on the docking module control assembly, utilizing the incorporated multifunction security access module (SAM) to encrypt the transaction (stored value, gift or phone card number, PIN, etc) prior to invoking a dialing routine with the attached cellular telephone. The cellular telephone dials the pre-configured number of the registration computer. The registration computer will validate the transaction as a initialization of a stored value, gift or phone card and will update the appropriate database with these values, and a response is returned to the microprocessor on the docking module control assembly, via the attached cellular telephone, that the transaction has been accepted.

With the transaction being accepted, the microprocessor on the docking module control assembly instructs the thermal docket printer to print a detailed slip for the customer to keep as a record of the transaction, and display a ‘Transaction Completed’ message on the screen of the attached cellular telephone.

For the recharge of a stored value card, gift card or phone card—the microprocessor on the docking module control assembly checks the card number and expiration date (if applicable) on track two of the card. The expiration date is checked against the network date of the attached cellular telephone. The microprocessor on the docking module control assembly conducts a Luhn validation of the card number to determine if the card may have been altered or forged. These checks are important to be able to reject obviously invalid or out-of-date cards prior to putting the retailer through the cost of an unnecessary cellular call.

If the microprocessor on the docking module control assembly determines that the expiration date has expired or the card is not valid, it prints out on the thermal docket printer a brief report advising that the card has expired or is invalid.

If the microprocessor on the docking module control assembly determines that the card is valid and is not expired, then the microprocessor on the docking module control assembly displays a message on the attached cellular telephone's screen advising the retailer to key in the amount to be added to the value of this card. The microprocessor on the docking module control assembly then prompts the retailer for their enabling PIN number.

Upon acceptance of the PIN number from the retailer, the microprocessor on the docking module control assembly, utilizing the incorporated multifunction security access module (SAM) to encrypt the transaction (stored value, gift or phone card number, PIN, etc) prior to invoking a dialing routine with the attached cellular telephone. The cellular telephone dials the pre-configured number of the registration computer. The registration computer will validate the transaction as a recharge of a stored value, gift or phone card and will update the appropriate database with these values, and a response is returned to the microprocessor on the docking module control assembly, via the attached cellular telephone, that the transaction has been accepted.

With the transaction being accepted, the microprocessor on the docking module control assembly instructs the thermal docket printer to print a detailed slip for the customer to keep as a record of the transaction, and display a ‘Transaction Completed’ message on the screen of the attached cellular telephone.

### DESCRIPTION OF THE DRAWINGS

Detailed drawings of the present invention are shown in the attached Figures, in which:

FIG. 1 shows a front view of the cellular telephone and docking module according to the present invention;

FIG. 2 shows a diagram of the major components of the cellular telephone and docking module and their interconnection, according to the present invention;

FIG. 3 shows a flow diagram of the actions and responses involved during the process of a typical transaction;

FIG. 4 shows a pictorial representation of the different types of card accepted by the present invention;

FIG. 5 shows a top view of the cellular telephone and docking module;

FIG. 6 shows a front view of the cellular telephone and docking module according to the present invention;

FIG. 7 shows a side view of the cellular telephone and docking module;

FIG. 8 shows a front view of a typical cellular telephone identifying the location of the cellular telephone auxiliary connector;

FIG. 9 shows a bottom view of a typical cellular telephone identifying the location of the cellular telephone auxiliary connector;

FIG. 10 shows a front view of the docking module without the cellular telephone identifying the mating connector for the cellular telephone auxiliary connector;

FIG. 11 shows a typical function of the signals found on the auxiliary connector of a typical Nokia cellular telephone.

### DETAILED DESCRIPTION OF THE PREFERRED EMBODIMENTS

The present invention is a cellular telephone docking module system that provides a secure point-of-sale system able to perform all normal functions of a typical landline based POS terminal, but in a mobile environment.

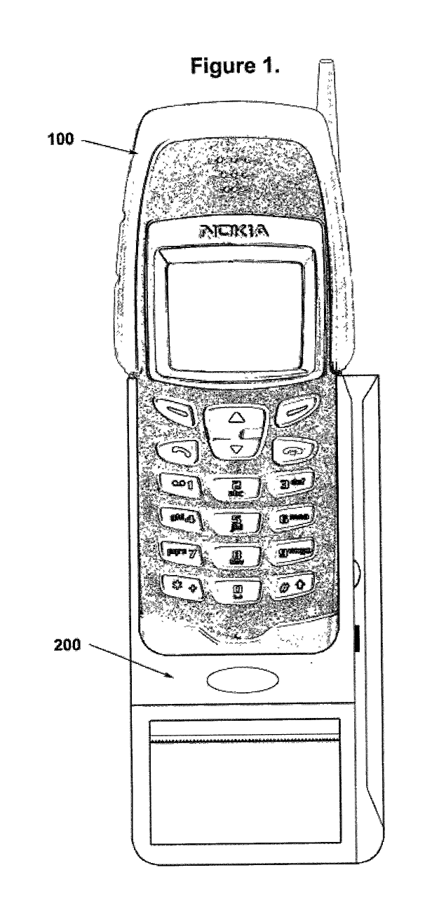

FIG. 1 is a diagrammatic illustration of a preferred embodiment of the system that includes a conventional cellular telephone 100, along with a docking module 200, that together form a secure point-of-sale system of the present invention. In one preferred embodiment, a NOKIA 5100 or 6100 series cellular telephone is utilized. The NOKIA 5100 or 6100 series cellular telephones are manufactured by Nokia, a Finnish manufacturer of cellular telephones and a leading supplier to the world market. Cellular Telephones made by other manufacturers may be used with the present invention.

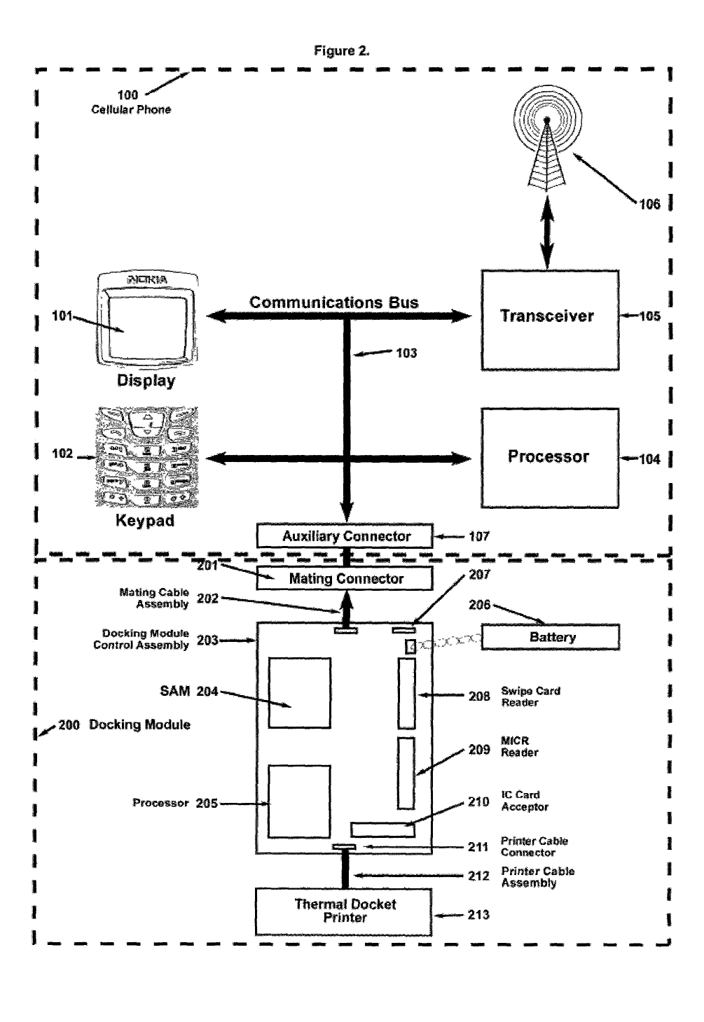

FIG. 2 schematically illustrates a typical cellular telephone as mated to the docking module 200 to form the secure point-of-sale system of the invention. Customarily, NOKIA 5100 or 6100 series cellular telephones have a display 101 and keypad 102 that are electronically connected to each other via a communications bus 103 that also communicates with a conventional microprocessor 104 and conventional transceiver unit 105. The transceiver unit 105 broadcasts to the cellular telephone network via a built-in antenna 106. The communications bus 103 terminates at an auxiliary connector 107 at the base of the phone cellular telephone. The above described hardware configuration is common in most cellular telephones. Nokia has established a particular protocol for communications among the display 101, keyboard 102, transceiver 105, and the microprocessor 104. This controlling protocol can be accessed from the cellular telephone auxiliary connector 107 to provide an additional location for controlling the cellular telephone 100.

The communications protocol, hardware and system described above are believed to be functionally substantially similar in all cellular telephones. Accordingly, the present invention is not intended to be limited to use with NOKIA cellular telephones, or limited to these specific NOKIA cellular telephone models.

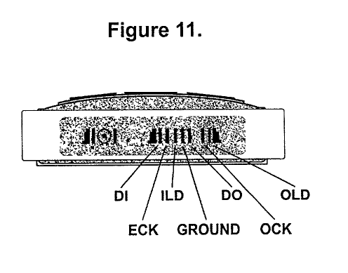

The cellular telephone auxiliary connector 107 typically contains 7 contacts (FIG. 11), including a control signal for data transmission OLD, a control signal for data reception ILD, a synchronizing clock OCK and data for transmission DO, a synchronizing clock ICK and data for reception DI, and ground. All of these signals are with reference to the cellular telephone.

The docking module 200 communicates with the cellular telephone 100 by passing signals through the cellular telephone auxiliary connector 107, via the mating connector 201 and the mating cable assembly 202, to the docking module control assembly 203. A docking module control assembly 205 includes microprocessor 205. A preferred microprocessor 205 for use in the present invention is a Motorola MC68HC711 microprocessor can control the functioning of the attached cellular telephone 100.

The docking module control assembly 203 also contains a conventional integrated circuit (IC) card reader 210 that mates with, and accepts data from IC cards or, as they are commonly known, “Smart Cards”, the docking module control assembly 203 also includes a conventional multifunction security access module (SAM) 204 used to perform all the required cryptographic functions as described herein. The docking module control assembly 203 also includes a MICR reader assembly 209 used to read checking account data from a check swiped through the MICR reader assembly 209. The assembly also includes a magnetic credit card reader 208 used to read information from ATM cards, credit cards, debit cards, phone cards, and stored value (Gift) cards that may be swiped through the magnetic credit card reader 208. Details on how magnetic credit card readers 208 function is similar to those disclosed in U.S. Pat. Nos. 5,729,591, 4,965,821, and 4,776,003. The docking module control assembly 203 also contains a docket printer connector 211 that mates with, preferably, a thermal docket printer cable assembly 212 from the thermal docket printer 213, typically a model CHTP-9024 from Axiohm, a French Based Thermal Printer manufacturer, a battery and cable assembly 206, and an external power connector 207 to allow the internal battery 206 to be recharged without removing the battery, or to use the unit from an external power source, such as a car cigarette lighter (not shown), power pack (not shown), or other source of electric power (not shown).

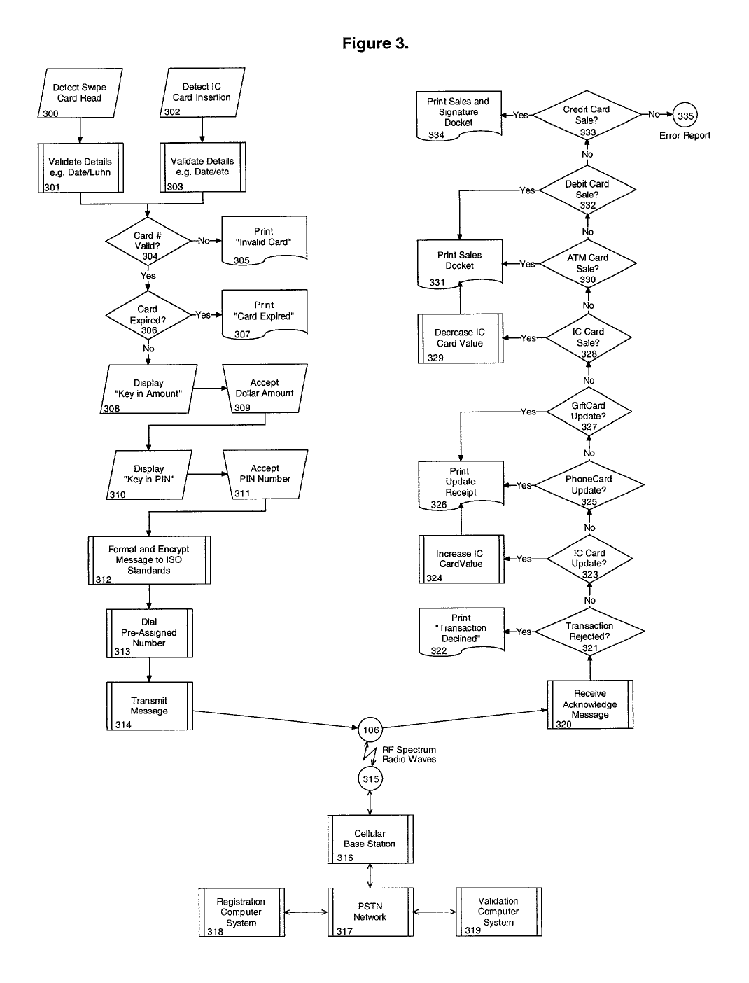

FIG. 3 is a diagrammatic flowchart illustrating typical operational steps and information flow for all of the embodiments of the present invention described herein. When the merchant swipes a magnetic strip based card through the docking module's magnetic credit card reader 208, the reader detects the card at step 300, then microprocessor performs a validation check on the account number read from the magnetic stripe card at step 300, microprocessor uses conventional validation routines such as the Luhn check, the Luhn check is a mathematical algorithm that checks the validity of the card number and check digit. The microprocessor also checks to see if the card has expired during step 301.

Alternatively, when the merchant or customer inserts an IC card 410 into the IC Card reader slot 214, the processor detects the IC card 410 insertion at step 302, and microprocessor performs a validation and expiration check on the account number read from the IC card 410 at step 303. The processor uses conventional validation routines as provided in the relevant ISO standards, such as ISO Standard 15408. Typically the processor determines whether it should authenticate the card offline using either offline static or dynamic data authentication based upon the card and terminal support for these methods.

Offline Static Data Authentication (SDA) validates that important application data has not been fraudulently altered since card personalization. The terminal validates static (unchanging) data from the card using the card's Issuer Public Key (PK) Certificate that contains the Issuer Public Key and a digital signature that contains a hash of important application data encrypted with the Issuer Private Key. The terminal recovers the Issuer Public Key from the Issuer PK Certificate and uses the recovered Issuer Public Key to recover the hash of application data from the digital signature. A match of the recovered hash with a hash of the actual application data proves that the data has not been altered. Offline Dynamic Data Authentication (DDA) validates that the card data has not been fraudulently altered and that the card is genuine. The terminal verifies the card static data in a similar manner to SDA. Then, the terminal requests that the card generate a cryptogram using dynamic (transaction unique) data from the card and terminal and an ICC Private Key. The terminal decrypts this dynamic signature using the ICC Public Key recovered from card data. A match of the recovered data to the original data verifies that the card is not a counterfeit card created with data skimmed (copied) from a legitimate card.

If the microprocessor, determines that the account number is not valid at step 304, an “Invalid Card” message is displayed on the cellular telephone's display 101, and also printed on the attached thermal docket printer 213, at step 305.

If the microprocessor, determines that the account number is valid at step 304, it checks the card expiration date against the cellular telephone's network date at step 306, and if the IC card has expired, a “Card Expired” message is displayed on the cellular telephone's display 101, and also printed on the attached thermal docket printer 213 at step 307.

If the microprocessor, determines that the offered card has not expired at step 306, a “Key in Amount” message or its equivalent, is displayed on the cellular telephone's display 101 at step 308, and the microprocessor, monitors the key presses on the keypad of the attached cellular telephone 102 to accept the transaction amount at step 309.

After the microprocessor, accepts the transaction amount at step 309, a “Key in PIN” message or its equivalent, is displayed on the cellular telephone's display at step 310, and the microprocessor, monitors the key presses on the keypad of the attached cellular telephone to accept the PIN number at step 311.

The microprocessor, formats and encrypts the information using the multifunction security access module (SAM) 204. Typically a multifunctional security access module (SAM) essentially acts as a fraud protection and control mechanism for smart card applications running on terminals such as this invention, which feature integrated smart card capabilities. Typically the chip that is embedded in the SAM contains proprietary information about a particular smart card scheme. When a customer inserts a smart card into the card reader, the SAM uses this proprietary information to verify that the customer's smart card is valid. Then, it checks to see if that card is intended for the smart card scheme currently in use. All this happens within a matter of seconds. If everything checks out properly, the terminal begins to process the transaction.

In some cases, electronic payments from a customer may actually be captured and securely stored directly on the SAM. The merchant can deposit this cash value into his or her account either electronically or physically.

Not all smart card-based loyalty or stored-value schemes rely on the same operating procedures, processing methods or standards. Because the embedded chip on each SAM stores proprietary information necessary to validate a card and match it to a particular scheme, it is not practical to have one SAM supporting multiple smart card applications. As a result, as smart card schemes proliferate, it has become desirable to have a multifunction security access module (SAM) 204 available in the POS terminal.

With multifunction security access module (SAM)s 204, merchants can take advantage of a variety of smart card-based programs at the same time. For example, a retailer might use one SAM to support Visa Cash, another for the Mondex electronic cash system, a third to handle stored-value gift cards, and still another SAM to implement a frequent shopper program. Each section of the multifunction security access module (SAM) 204 would be responsible for checking a smart card when inserted, and ensuring that it is only used as part of a particular scheme.

The encryption is performed conventionally, in accordance with the relevant ISO standards, such as ISO 15408 at step 312, and the microprocessor instructs the attached cellular telephone to dial a pre-assigned number at step 313.

Microprocessor transmits the information via the attached cellular telephone 100 via the cellular telephone's antenna 106 at step 106, the cellular base station antenna at step 315 passes this information on to the cellular telephone base station at step 316. The cellular base station at step 316 sends the information, via the PSTN Network at step 317, to the registration computer system at step 318.

The registration computer system at step 318, if required by the credit issuing authority, connects to a validation computer system at step 319 via the PSTN Network at step 317 to seek authorization for the transaction. If the transaction is authorized or declined by either the validation computer system at step 319 or the registration computer system at step 318, the resultant message is returned via the PSTN Network at step 317, to the cellular base station at step 316, where this data is transmitted via the cellular base station's antenna array at step 315 back to the originating cellular telephone via the cellular telephone's antenna 106 at step 106, where it is received at step 320 and passed on to the microprocessor, for further processing at step 321.

The microprocessor, determines if the transaction was declined at step 321, and a “Transaction Declined” message is displayed on the cellular telephone's display 101, and also printed on the thermal docket printer 213 at step 322.

The microprocessor, determines if the transaction was an IC card update transaction at step 323, then the stored value on the IC card is increased by the transaction amount (minus any commercial commissions or fees) at step 324, and an “Update Accepted” message is displayed on the cellular telephone's display 101 and a receipt of the transaction is then printed on the thermal docket printer 213 at step 326.

The microprocessor, determines if the transaction was a phone card update transaction at step 325, and an “Update Accepted” message is displayed on the cellular telephone's display 101, and a receipt of the transaction is then printed on the thermal docket printer 213 at step 326.

The microprocessor, determines if the transaction was a stored value (Gift) card update transaction at step 327, and an “Update Accepted” message is displayed on the cellular telephone's display 101, and a receipt of the transaction is then printed on the thermal docket printer 213 at step 326.

The microprocessor, determines if the transaction was an IC card sales transaction at step 328, then the stored value on the IC card is decreased by the transaction amount (plus any commercial commissions or fees) 329, and an “Transaction Accepted” message is displayed on the cellular telephone's display 101, and a sales receipt of the transaction is then printed on the thermal docket printer 213 at step 331.

The microprocessor, determines if the transaction was a ATM card sales transaction at step 330, and a “Transaction Accepted” message is displayed on the cellular telephone's display 101, and a sales receipt of the transaction is then printed on the thermal docket printer 213 at step 331.

The microprocessor, determines if the transaction was a debit card sales transaction at step 332, and a “Transaction Accepted” message is displayed on the cellular telephone's display 101, and a sales receipt of the transaction is then printed on the thermal docket printer 213 at step 331.

The microprocessor, determines if the transaction was a credit card sales transaction at step 333, and a “Transaction Accepted” message is displayed on the cellular telephone's display 101, and a sales receipt and signature slip for the transaction is then printed on the thermal docket printer 213 at step 334.

The microprocessor, determines if the transaction was not recognized as one of the above transactions at step 335, then a “Transaction Error” message is displayed on the cellular telephone's display 101, and an error report of the transaction is then printed on the thermal docket printer 213 at step 335.

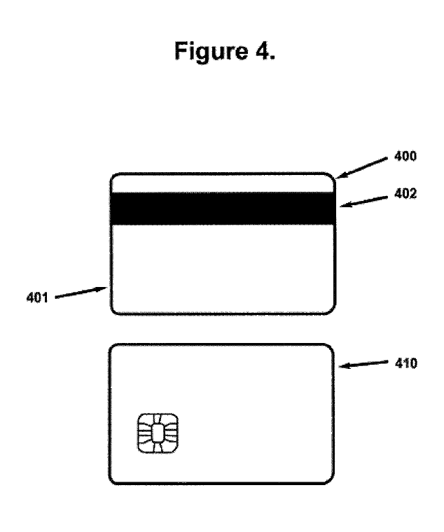

FIG. 4 diagrammatically illustrates the various types of cards accepted by the secure point-of-sale system of the present invention. The card types accepted are:—magnetic stripes 400, that is comprised of a base plastic card 401, a magnetic stripe 402, and other printed and embossed information that is pertinent to the card (not shown). Further definition of magnetic stripe encoding may be found in ANSI X4.16-1983 “American National Standard for Financial Services—Financial Transaction Cards—Magnetic Stripe Encoding”.

The function of the card is in accordance to the information contained within Track 2 that is recorded upon the magnetic stripe 402 on the card. These magnetic stripe cards can function as:—ATM cards, credit cards, debit cards, phone cards, and stored value (Gift) cards.

The secure point-of-sale system also accepts all forms of IC cards 410 that are capable of replacing all of the magnetic strip cards defined above. The IC cards 410 described herein conform in general to ISO 7810, ISO 7813, ISO 7816, ISO 10202 and ISO 14443.

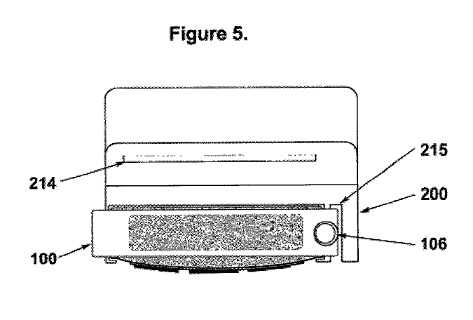

FIG. 5 is a diagrammatic illustration of a top view of a first preferred embodiment of the invention. It shows the cellular telephone 100 and docking module 200 along with location details for the cellular telephone's antenna 106, keypad 102 locations, as well as the IC card reader slot 214 and magnetic card reader/check MICR reader slot 215 locations on the docking module 200.

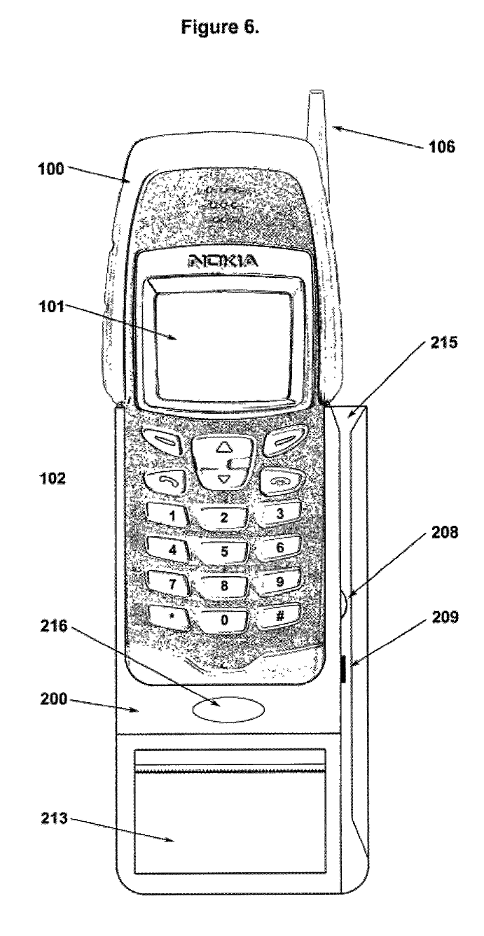

FIG. 6 is a diagrammatic illustration of a front view of a first preferred embodiment of the invention. It shows the cellular telephone 100 and docking module 200 along with location details for the cellular telephone's display 101, keypad 102, and antenna 106, as well as the docking module's magnetic card reader/check MICR reader slot 215, the magnetic credit card reader 208, the MICR reader assembly 209, phone release/locking button 216 and thermal docket printer 213.

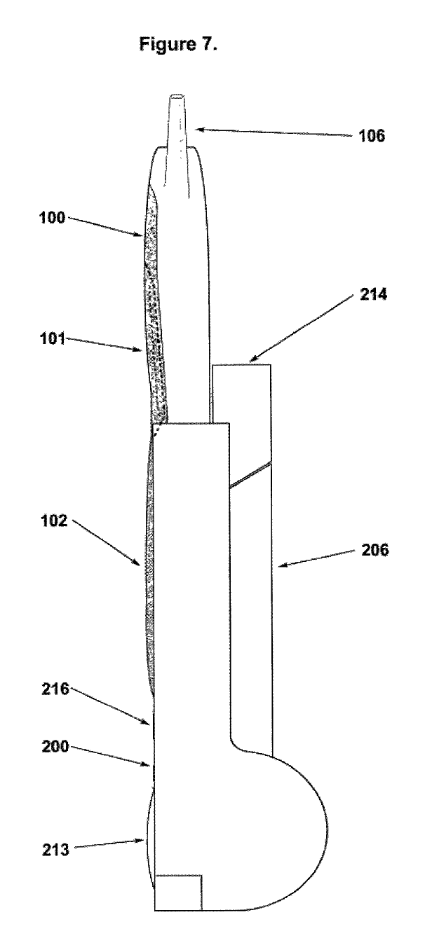

FIG. 7 is a diagrammatic illustration of a side view of a first preferred embodiment of the invention. It shows the cellular telephone 100 and docking module 200 along with location details for the cellular telephone's display 101, keypad 102, and antenna 106, as well as the docking module's IC card reader slot 214, the battery and cable assembly 206, the phone release/locking button 216 and thermal docket printer 213.

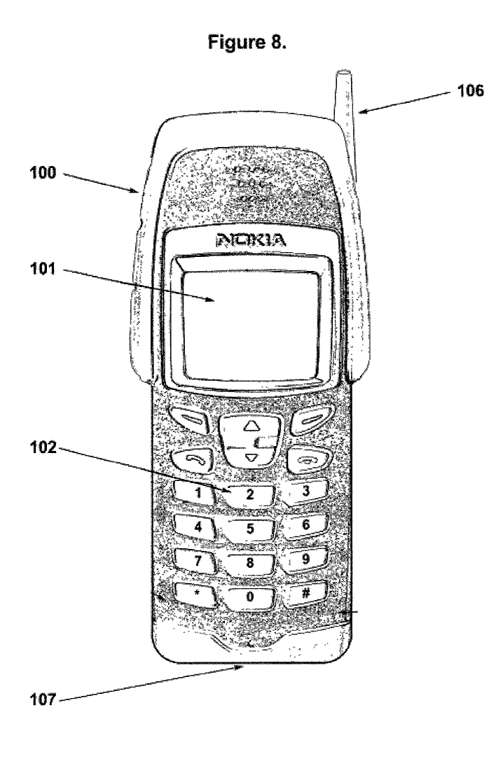

FIG. 8 is a diagrammatic illustration of a front view of the cellular telephone 100 along with location details the cellular telephone's display 101, keypad 102, cellular telephone auxiliary connector 107, and antenna 106.

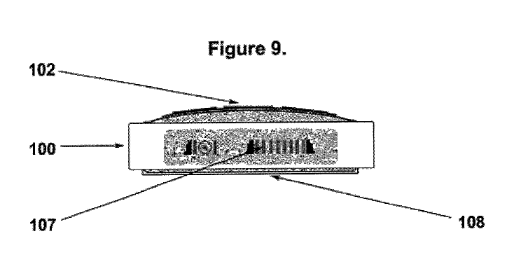

FIG. 9 is a diagrammatic illustration of a bottom view of the cellular telephone 100 along with location details for the cellular telephone's keypad 102, cellular telephone auxiliary connector 107, and battery 206.

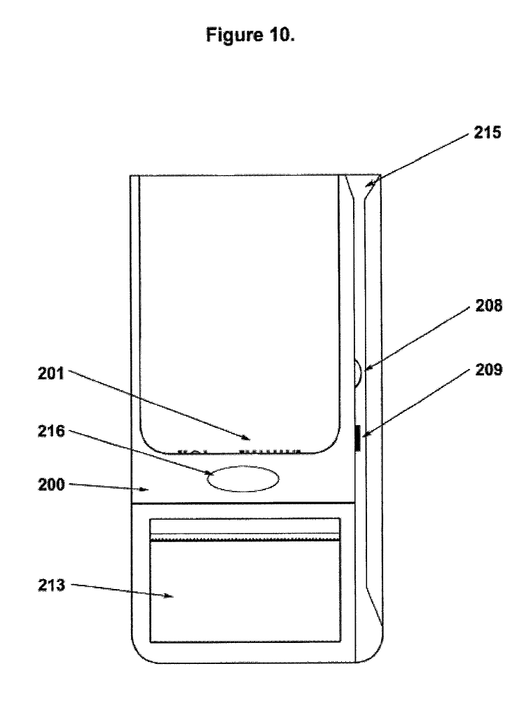

FIG. 10 is a diagrammatic illustration of a top view of the docking module 200 along with location details for the, phone release/locking button 216, thermal docket printer 213, magnetic card reader/check MICR reader slot 215, magnetic credit card reader 208, and MICR reader assembly 209.

FIG. 11 gives a diagrammatic representation of the contact and signal configuration of a typical cellular telephone. It shows the normal signals encountered on such a connector, the cellular telephone's including a control signal for data transmission OLD, a control signal for data reception ILD, a synchronizing clock OCK and data for transmission DO, a synchronizing clock ICK and data for reception DI, and ground. All of these signals are with reference to the cellular telephone.

In operation, the cellular telephone 100 is electrically connected to the docking module control assembly 203 via the cellular telephone auxiliary connector 107. The cellular telephone 100 includes, as is customary with most cellular or mobile telephones, a keypad 102, and display 101. All of the keys 102, on the keypad are utilized by this embodiment, and key presses can be mimicked on the docking module control assembly 203 via the control of the microprocessor. When an operator presses a key on the keypad 102, the code for the pressed key is sent via the cellular telephone's communications bus 103, to the cellular telephone's 100 microprocessor 104. The cellular telephone's 100 microprocessor 104 will then act upon that key press information.

In this invention, the docking module's 200 microprocessor is continually monitoring the activity of the cellular telephone's communications bus 103, via the cellular telephone's cellular telephone auxiliary connector 107. This way, the docking module's 200 microprocessor is continually aware of activity within the cellular telephone 100, and can capture information of each key press on the keypad 102, or can present key press information to the cellular telephone's 100 microprocessor 104 via the cellular telephone's cellular telephone auxiliary connector 107 to the cellular telephone's communications bus 103, and from there to the cellular telephone's 100 microprocessor 104 for processing. This mimics the key presses normally entered by the user to control the functioning of the cellular telephone 100. In this manner, all the cellular telephone 100 functions and capabilities can be controlled.

All cellular telephones keypads act in a similar manner to control the functioning of the attached cellular telephone 100. A conventional cellular telephone 100 for use in the present invention, preferably includes a display 101 and keyboard 102 that are electronically connected via a communications bus 103 to microprocessor 104 and transceiver unit 105.

As discussed in detail hereinafter, electronic signals on the data lines (Data Rx DI and Data Tx DO) are digitally formatted. In order to describe the present invention, signals are referenced with respect to the cellular telephone 100.

It is important to note that the signals present on the cellular telephone auxiliary connector 107 are monitored by the docking module control assembly microprocessor on the docking module control assembly 203. When required, the docking module control assembly microprocessor on the docking module control assembly 203 can control the functioning of the cellular telephone 100 by mimicking key presses from the cellular telephone's own keypad 102, such as would be done when initiating the call to the registration computer. The cellular telephone 100 has not been modified in any manner, but just clips into the docking module 200 and the only electrical interconnection between the two is via the cellular telephone auxiliary connector 107. The cellular telephone 100 and the docking module 200 are each powered from their own internal battery sources, battery 108 for the cellular telephone, and the battery and cable assembly 206 for the docking module.

As background, a cellular telephone operates in the following manner: In general, the user, after powering up the cellular telephone 100 by depressing one of the control keys on the keypad 102, would then normally depress a sequence of keys on the keypad 102 and that these key strokes would be displayed on the display 101. Other operational data may also be displayed on the display 101 to advise the user of network conditions, time, location, etc. However, the display 101 principally shows the telephone number being dialed. At the completion of the successful input of the required telephone number, the user would depress a send function key on the keypad 102. Normally, the cellular telephone will then be connected to a local cellular system and ultimately to the requested destination telephone. This dialing information is converted into the appropriate data stream by the cellular telephone's microcontroller 104 for conversion into an appropriate radio frequency signal by the transceiver unit 105 and applied to the cellular telephone's antenna 106. The cellular telephone's antenna 106 then transmits the radio signals to antenna 315, which is part of the local cellular network or carrier 316.

According to the present invention, the local cellular network 316 is electronically coupled and is part of the telecommunications PSTN network 317. Ultimately, the telecommunications network will connect the call originating from the secure point-of-sale system comprising the cellular telephone 100 and the docking module 200 to the registration computer for validation of the transaction.

Most importantly in the present invention, the docking module control assembly microprocessor initially verifies the credit card data before encrypting the credit card information utilizing the inbuilt multifunction security access module (SAM) which formats the data as per the ISO Standard 15408 (and similar standards) before initiating the call to the registration computer 318 within the telecommunications network, where the credit card data is further validated through a validation or verification computer system in the credit card issuers premises or some such recognized credit clearing facility. Upon verification, which takes about 7 to 15 seconds, the registration computer 318 will respond, via the telecommunications network 317 to the cellular telephone 100 where the docking module control assembly microprocessor will display the result of the credit validation on the display of the cellular telephone 101 and print a report on the thermal docket printer 213 contained within the docking module 200.

Upon the initial mating and powering on of the cellular telephone 100 and the docking module 200, the microprocessor on the docking module control assembly will interrogate the microprocessor of the cellular telephone 104 using the predefined protocol of the cellular telephone to determine the current network time and date for the local cellular network.

The preferred embodiment according to the present invention is one in which a credit card 400 employing a standard magnetic strip credit card issued by a credit issuing body (e.g., Visa, Master Card, Maestro. etc.) is used during the transaction to debit the value of the transaction to the credit card account. This embodiment will now be described in detail hereinbelow with reference to the accompanying drawings.

The retailer swipes the credit card 400 through the swipe card slot 215 in the docking module 200, the action of swiping the credit card 400 through the swipe card slot 215 in the docking module 200 causes the magnetic information contained on the credit card 400 to be read by the magnetic read head 208 and associated electronics on the docking module control assembly 203 in such a manner as to present to the docking module microprocessor the information contained on stripe 2 of the credit card 400.

This information includes, inter alia, identification of the credit card issuer and account number along with the credit card expiration date. Further definition of magnetic stripe encoding may be found in ANSI X4.16-1983“American National Standard for Financial Services—Financial Transaction Cards—Magnetic Stripe Encoding”.

The microprocessor on the docking module control assembly 203 checks the credit card 400 number and expiration date on track two of the card. The expiration date is checked against the network date of the attached cellular telephone 100. The microprocessor on the docking module control assembly 203 conducts a Luhn validation of the credit card number to determine if the credit card has been altered or forged.

If the microprocessor on the docking module control assembly 203 determines that the expiration date has expired or the credit card is not valid, it prints out on the thermal docket printer 213 a brief report advising that the credit card has expired or is invalid.

If the microprocessor on the docking module control assembly 203 determines that the credit card is valid and is not expired, then the microprocessor on the docking module control assembly 203 displays a message on the attached cellular telephone's 101 screen advising the retailer to key in the amount to be debited to the account of this credit card. The microprocessor on the docking module control assembly 203 then prompts the customer for their enabling PIN number.

Upon acceptance of the PIN number from the customer, the microprocessor on the docking module control assembly 203, utilizing the incorporated multifunction security access module (SAM) 204 to encrypt the transaction (credit card number, PIN, etc) prior to invoking a dialing routine with the attached cellular telephone 100. The cellular telephone 100 dials the pre-configured number of the registration computer FIG. 3—318. The registration computer 318 further validates the credit card data through a validation or verification computer system FIG. 3—319 in the credit card issuer's premises or some such recognized credit card clearing facility. Upon verification, which takes about 7 to 15 seconds, a response is returned to the microprocessor on the docking module control assembly 203, via the attached cellular telephone 100, that the transaction has been accepted.

With the transaction being accepted, the microprocessor on the docking module control assembly 203 instructs the thermal docket printer 213 to print a detailed slip for the customer to sign and return one copy to the retailer as a record of the transaction, the duplicate copy is given to the customer as a record of the transaction, and display a ‘Transaction Completed’ message on the screen of the attached cellular telephone 100.

Further variation is achieved in the second embodiment according to the present invention is one in which a ATM card 400 employing a standard magnetic strip issued by a bank or similar issuing body is utilized in a transaction to charge the value of that transaction against the value of an ATM card account. This embodiment will now be described in detail hereinbelow with reference to the accompanying drawings.

The retailer swipes the ATM card 400 through the swipe card slot 215 in the docking module 200, the action of swiping the ATM card 400 through the swipe card slot 215 in the docking module 200 causes the magnetic information contained on the ATM card 400 to be read by the magnetic read head 208 and associated electronics on the docking module control assembly 203 in such a manner as to present to the docking module microprocessor the information contained on stripe 2 of the ATM card 400.

This information includes, inter alia, identification of the ATM card issuer and account number along with the ATM card expiration date. Further definition of magnetic stripe encoding may be found in ANSI X4.16-1983 “American National Standard for Financial Services—Financial Transaction Cards—Magnetic Stripe Encoding”.

The microprocessor on the docking module control assembly 203 checks the ATM card 400 number and expiration date on track two of the ATM card. The expiration date is checked against the network date of the attached cellular telephone 100. The microprocessor on the docking module control assembly 203 conducts a Luhn validation of the ATM card number to determine if the ATM card has been altered or forged.

If the microprocessor on the docking module control assembly 203 determines that the expiration date has expired or the ATM card is not valid, it prints out on the thermal docket printer 213 a brief report advising that the ATM card has expired or is invalid.

If the microprocessor on the docking module control assembly 203 determines that the ATM card is valid and is not expired, then the microprocessor on the docking module control assembly 203 displays a message on the attached cellular telephone's 101 screen advising the retailer to key in the amount to be debited to the account of this ATM card. The microprocessor on the docking module control assembly 203 then prompts the customer for their enabling PIN number.

Upon acceptance of the PIN number from the customer, the microprocessor on the docking module control assembly 203, utilizing the incorporated multifunction security access module (SAM) 204 to encrypt the transaction (ATM card number, PIN, etc) prior to invoking a dialing routine with the attached cellular telephone 100. The cellular telephone 100 dials the pre-configured number of the registration computer 318. The registration computer 318 further validates the ATM card through a validation or verification computer system in the ATM card issuer's premises or some such recognized ATM card clearing facility. Upon verification, which takes about 7 to 15 seconds, a response is returned to the microprocessor on the docking module control assembly 203, via the attached cellular telephone 100, that the transaction has been accepted.

With the transaction being accepted, the microprocessor on the docking module control assembly 203 instructs the thermal docket printer 213 to print a detailed duplicate slip as a record of the transaction, the original is kept by the retailer, with the duplicate copy for the customer to keep, and display a ‘Transaction Completed’ message on the screen of the attached cellular telephone 100.

Further variation is achieved in the third embodiment according to the present invention is one in which a debit card 400 employing a standard magnetic strip issued by a bank or similar issuing body is utilized in a transaction to charge the value of that transaction against the value of an debit card account. This embodiment will now be described in detail hereinbelow with reference to the accompanying drawings.

The retailer swipes the debit card 400 through the swipe card slot 215 in the docking module 200, the action of swiping the debit card 400 through the swipe card slot 215 in the docking module 200 causes the magnetic information contained on the debit card 400 to be read by the magnetic read head 208 and associated electronics on the docking module control assembly 203 in such a manner as to present to the docking module microprocessor the information contained on stripe 2 of the debit card 400.

This information includes, inter alia, identification of the debit card issuer and account number along with the debit card expiration date. Further definition of magnetic stripe encoding may be found in ANSI X4.16-1983 “American National Standard for Financial Services—Financial Transaction Cards—Magnetic Stripe Encoding”.

The microprocessor on the docking module control assembly 203 checks the debit card 400 number and expiration date on track two of the debit card. The expiration date is checked against the network date of the attached cellular telephone 100. The microprocessor on the docking module control assembly 203 conducts a Luhn validation of the debit card number to determine if the debit card has been altered or forged.

If the microprocessor on the docking module control assembly 203 determines that the expiration date has expired or the debit card is not valid, it prints out on the thermal docket printer 213 a brief report advising that the debit card has expired or is invalid.

If the microprocessor on the docking module control assembly 203 determines that the debit card is valid and is not expired, then the microprocessor on the docking module control assembly 203 displays a message on the attached cellular telephone's 101 screen advising the retailer to key in the amount to be debited to the account of this debit card. The microprocessor on the docking module control assembly 203 then prompts the customer for their enabling PIN number.

Upon acceptance of the PIN number from the customer, the microprocessor on the docking module control assembly 203, utilizing the incorporated multifunction security access module (SAM) 204 to encrypt the transaction (debit card number, PIN, etc) prior to invoking a dialing routine with the attached cellular telephone 100. The cellular telephone 100 dials the pre-configured number of the registration computer 318. The registration computer 318 further validates the debit card through a validation or verification computer system in the debit card issuer's premises or some such recognized debit card clearing facility. Upon verification, which takes about 7 to 15 seconds, a response is returned to the microprocessor on the docking module control assembly 203, via the attached cellular telephone 100, that the transaction has been accepted.

With the transaction being accepted, the microprocessor on the docking module control assembly 203 instructs the thermal docket printer 213 to print a detailed duplicate slip as a record of the transaction, the original is kept by the retailer, with the duplicate copy for the customer to keep, and display a ‘Transaction Completed’ message on the screen of the attached cellular telephone 100.

Further variation is achieved in the fourth embodiment according to the present invention is one in which a IC card 410 employing an integrated IC chip issued by a bank, credit card or similar issuing body is utilized in a transaction to charge the value of that transaction against the value of an IC card account. This embodiment will now be described in detail hereinbelow with reference to the accompanying drawings.

The retailer or customer inserts the IC card 410 into the IC card slot 214 in the docking module 200, the action of inserting the IC card 410 into the IC card slot 215 215 in the docking module 200 causes the some of the information contained on the IC card 410 to be read by the IC card acceptor 210 (to ISO7816) and associated electronics on the docking module control assembly 203 in such a manner as to present to the docking module microprocessor the information contained on the IC card 410.

This information includes, inter alia, identification of the IC card issuer and account number along with the IC card expiration date.

The microprocessor on the docking module control assembly 203 checks the IC card 410 number and expiration date from the information read from the IC card. The expiration date is checked against the network date of the attached cellular telephone 100. The microprocessor on the docking module control assembly 203 conducts validation of the IC card number to determine if the IC card has been altered or forged.

If the microprocessor on the docking module control assembly 203 determines that the expiration date has expired or the IC card is not valid, it prints out on the thermal docket printer 213 a brief report advising that the IC card has expired or is invalid.

If the microprocessor on the docking module control assembly 203 determines that the IC card is valid and is not expired, then the microprocessor on the docking module control assembly 203 displays a message on the attached cellular telephone's 101 screen advising the retailer to key in the amount to be debited to the account of this IC card. The microprocessor on the docking module control assembly 203 then prompts the customer for their enabling PIN number.

Upon acceptance of the PIN number from the customer, the microprocessor on the docking module control assembly 203, utilizing the incorporated multifunction security access module (SAM) 204 to encrypt the transaction (IC card number, PIN, etc) prior to invoking a dialing routine with the attached cellular telephone cellular telephone. The cellular telephone 100 dials the pre-configured number of the registration computer 318. The registration computer 318 further validates the IC card through a validation or verification computer system in the IC card issuer's premises or some such recognized IC card clearing facility. Upon verification, which takes about 7 to 15 seconds, a response is returned to the microprocessor on the docking module control assembly 203, via the attached cellular telephone 100, that the transaction has been accepted.

With the transaction being accepted, the microprocessor on the docking module control assembly 203 instructs the thermal docket printer 213 to print a detailed duplicate slip as a record of the transaction, the original is kept by the retailer, with the duplicate copy for the customer to keep, and display a ‘Transaction Completed’ message on the screen of the attached cellular telephone 100.

Further variation is achieved in the fifth embodiment according to the present invention is one in which a phone card 400 employing a standard magnetic strip issued by a telephone company or similar issuing body is utilized in a transaction to charge the value of that transaction against the value of an phone card account. This embodiment will now be described in detail hereinbelow with reference to the accompanying drawings.

The retailer swipes the phone card 400 through the swipe card slot 215 in the docking module 200, the action of swiping the phone card 400 through the swipe card slot 215 in the docking module 200 causes the magnetic information contained on the phone card 400 to be read by the magnetic read head 208 and associated electronics on the docking module control assembly 203 in such a manner as to present to the docking module microprocessor the information contained on stripe 2 of the phone card 400.

This information includes, inter alia, identification of the phone card issuer and account number along with the phone card expiration date. Further definition of magnetic stripe encoding may be found in ANSI X4.16-1983 “American National Standard for Financial Services—Financial Transaction Cards—Magnetic Stripe Encoding”.

The microprocessor on the docking module control assembly 203 checks the phone card 400 number and expiration date on track two of the phone card. The expiration date is checked against the network date of the attached cellular telephone 100. The microprocessor on the docking module control assembly 203 conducts a Luhn validation of the phone card number to determine if the phone card has been altered or forged.

If the microprocessor on the docking module control assembly 203 determines that the expiration date has expired or the phone card is not valid, it prints out on the thermal docket printer 213 a brief report advising that the phone card has expired or is invalid.

If the microprocessor on the docking module control assembly 203 determines that the phone card is valid and is not expired, then the microprocessor on the docking module control assembly 203 displays a message on the attached cellular telephone's 101 screen advising the retailer to key in the amount to be debited to the account of this phone card. The microprocessor on the docking module control assembly 203 then prompts the retailer for their enabling PIN number.

Upon acceptance of the PIN number from the retailer, the microprocessor on the docking module control assembly 203, utilizing the incorporated multifunction security access module (SAM) 204 to encrypt the transaction (phone card number, PIN, etc) prior to invoking a dialing routine with the attached cellular telephone 100. The cellular telephone 100 dials the pre-configured number of the registration computer 318. The registration computer 318 further validates the phone card through a validation or verification computer system in the phone card issuer's premises or some such recognized phone card clearing facility. Upon verification, which takes about 7 to 15 seconds, a response is returned to the microprocessor on the docking module control assembly 203, via the attached cellular telephone 100, that the transaction has been accepted.

With the transaction being accepted, the microprocessor on the docking module control assembly 203 instructs the thermal docket printer 213 to print a detailed duplicate slip as a record of the transaction, the original is kept by the retailer, with the duplicate copy for the customer to keep, and display a ‘Transaction Completed’ message on the screen of the attached cellular telephone 100.

Further variation is achieved in the sixth embodiment according to the present invention is one in which a stored value (Gift) card 400 employing a standard magnetic strip issued by a retail store or similar issuing body is utilized in a transaction to charge the value of that transaction against the value of a stored value (Gift) card account. This embodiment will now be described in detail hereinbelow with reference to the accompanying drawings.

The retailer swipes the stored value (Gift) card 400 through the swipe card slot 215 in the docking module 200, the action of swiping the stored value (Gift) card 400 through the swipe card slot 215 in the docking module 200 causes the magnetic information contained on the stored value (Gift) card 400 to be read by the magnetic read head 208 and associated electronics on the docking module control assembly 203 in such a manner as to present to the docking module microprocessor the information contained on stripe 2 of the stored value (Gift) card 400.

This information includes, inter alia, identification of the stored value (Gift) card issuer and account number along with the stored value (Gift) card expiration date. Further definition of magnetic stripe encoding may be found in ANSI X4.16-1983 “American National Standard for Financial Services—Financial Transaction Cards—Magnetic Stripe Encoding”.

The microprocessor on the docking module control assembly 203 checks the stored value (Gift) card 400 number and expiration date on track two of the stored value (Gift) card. The expiration date is checked against the network date of the attached cellular telephone 100. The microprocessor on the docking module control assembly 203 conducts a Luhn validation of the stored value (Gift) card number to determine if the stored value (Gift) card has been altered or forged.

If the microprocessor on the docking module control assembly 203 determines that the expiration date has expired or the stored value (Gift) card is not valid, it prints out on the thermal docket printer 213 a brief report advising that the stored value (Gift) card has expired or is invalid.

If the microprocessor on the docking module control assembly 203 determines that the stored value (Gift) card is valid and is not expired, then the microprocessor on the docking module control assembly 203 displays a message on the attached cellular telephone's 101 screen advising the retailer to key in the amount to be debited to the account of this stored value (Gift) card. The microprocessor on the docking module control assembly 203 then prompts the retailer for their enabling PIN number.

Upon acceptance of the PIN number from the retailer, the microprocessor on the docking module control assembly 203, utilizing the incorporated multifunction security access module (SAM) 204 to encrypt the transaction (stored value (Gift) card number, PIN, etc) prior to invoking a dialing routine with the attached cellular telephone 100. The cellular telephone cellular telephone dials the pre-configured number of the registration computer 318. The registration computer 318 further validates the stored value (Gift) card through a validation or verification computer system in the stored value (Gift) card issuer's premises or some such recognized stored value (Gift) card clearing facility. Upon verification, which takes about 7 to 15 seconds, a response is returned to the microprocessor on the docking module control assembly 203, via the attached cellular telephone 100, that the transaction has been accepted.

With the transaction being accepted, the microprocessor on the docking module control assembly 203 instructs the thermal docket printer 213 to print a detailed duplicate slip as a record of the transaction, the original is kept by the retailer, with the duplicate copy for the customer to keep, and display a ‘Transaction Completed’ message on the screen of the attached cellular telephone 100.

Further variation is achieved in the seventh embodiment according to the present invention is one in which a IC card 410 employing an integrated IC chip issued by a bank, credit card or similar issuing body is utilized in a transaction to add value to the IC card. This embodiment will now be described in detail hereinbelow with reference to the accompanying drawings.

The retailer or customer inserts the IC card 410 into the IC card slot 214 in the docking module 200, the action of inserting the IC card 410 into the IC card slot 214 in the docking module 200 causes the some of the information contained on the IC card 410 to be read by the IC card reader 210 (to ISO7816) and associated electronics on the docking module control assembly 203 in such a manner as to present to the docking module microprocessor the information contained on the IC card 410.

This information includes, inter alia, identification of the IC card issuer and account number along with the IC card expiration date.

The microprocessor on the docking module control assembly 203 checks the IC card 410 number and expiration date from the information read from the IC card. The expiration date is checked against the network date of the attached cellular telephone 100. The microprocessor on the docking module control assembly 203 conducts validation of the IC card number to determine if the IC card has been altered or forged.

If the microprocessor on the docking module control assembly 203 determines that the expiration date has expired or the IC card is not valid, it prints out on the thermal docket printer 213 a brief report advising that the IC card has expired or is invalid.

If the microprocessor on the docking module control assembly 203 determines that the IC card is valid and is not expired, then the microprocessor on the docking module control assembly 203 displays a message on the attached cellular telephone's 101 screen advising the retailer to key in the amount to be credited to the account of this IC card. The microprocessor on the docking module control assembly 203 then prompts the customer for their enabling PIN number.

Upon acceptance of the PIN number from the customer, the microprocessor on the docking module control assembly 203, utilizing the incorporated multifunction security access module (SAM) 204 to encrypt the transaction (IC card number, PIN, etc) prior to invoking a dialing routine with the attached cellular telephone 100. The cellular telephone 100 dials the pre-configured number of the registration computer 318. The registration computer 318 further validates the IC card through a validation or verification computer system in the IC card issuer's premises or some such recognized IC card clearing facility. Upon verification, which takes about 7 to 15 seconds, a response is returned to the microprocessor on the docking module control assembly 203, via the attached cellular telephone 100, that the transaction has been accepted.

With the transaction being accepted, the microprocessor on the docking module control assembly 203 instructs the thermal docket printer 213 to print a detailed duplicate slip as a record of the transaction, the original is kept by the retailer, with the duplicate copy for the customer to keep, and display a ‘Transaction Completed’ message on the screen of the attached cellular telephone 100.

Further variation is achieved in the eighth embodiment according to the present invention is one in which a phone card 400 employing a standard magnetic strip issued by a telephone company or similar issuing body is utilized in a transaction to add value to the phone card. This embodiment will now be described in detail hereinbelow with reference to the accompanying drawings.

The retailer swipes the phone card 400 through the swipe card slot 215 in the docking module 200, the action of swiping the phone card 400 through the swipe card slot 215 in the docking module 200 causes the magnetic information contained on the phone card 400 to be read by the magnetic read head 208 and associated electronics on the docking module control assembly 203 in such a manner as to present to the docking module microprocessor the information contained on stripe 2 of the phone card 400.

This information includes, inter alia, identification of the phone card issuer and account number along with the phone card expiration date. Further definition of magnetic stripe encoding may be found in ANSI X4.16-1983 “American National Standard for Financial Services—Financial Transaction Cards—Magnetic Stripe Encoding”.

The microprocessor on the docking module control assembly 203 checks the phone card 400 number and expiration date on track two of the phone card. The expiration date is checked against the network date of the attached cellular telephone 100. The microprocessor on the docking module control assembly 203 conducts a Luhn validation of the phone card number to determine if the phone card has been altered or forged.

If the microprocessor on the docking module control assembly 203 determines that the expiration date has expired or the phone card is not valid, it prints out on the thermal docket printer 213 a brief report advising that the phone card has expired or is invalid.

If the microprocessor on the docking module control assembly 203 determines that the phone card is valid and is not expired, then the microprocessor on the docking module control assembly 203 displays a message on the attached cellular telephone's 101 screen advising the retailer to key in the amount to be credited to the account of this phone card. The microprocessor on the docking module control assembly 203 then prompts the retailer for their enabling PIN number.

Upon acceptance of the PIN number from the retailer, the microprocessor on the docking module control assembly 203, utilizing the incorporated multifunction security access module (SAM) 204 to encrypt the transaction (phone card number, PIN, etc) prior to invoking a dialing routine with the attached cellular telephone 100. The cellular telephone 100 dials the pre-configured number of the registration computer 318. The registration computer 318 further validates the phone card through a validation or verification computer system in the phone card issuer's premises or some such recognized phone card clearing facility. Upon verification, which takes about 7 to 15 seconds, a response is returned to the microprocessor on the docking module control assembly 203, via the attached cellular telephone 100, that the transaction has been accepted.

With the transaction being accepted, the microprocessor on the docking module control assembly 203 instructs the thermal docket printer 213 to print a detailed duplicate slip as a record of the transaction, the original is kept by the retailer, with the duplicate copy for the customer to keep, and display a ‘Transaction Completed’ message on the screen of the attached cellular telephone 100.

Further variation is achieved in the ninth embodiment according to the present invention is one in which a stored value (Gift) card 400 employing a standard magnetic strip issued by a retail store or similar issuing body is utilized in a transaction to add value to the stored value (Gift) card. This embodiment will now be described in detail hereinbelow with reference to the accompanying drawings.

The retailer swipes the stored value (Gift) card 400 through the swipe card slot 215 in the docking module 200, the action of swiping the stored value (Gift) card 400 through the swipe card slot 215 in the docking module 200 causes the magnetic information contained on the stored value (Gift) card 400 to be read by the magnetic read head 208 and associated electronics on the docking module control assembly 203 in such a manner as to present to the docking module microprocessor the information contained on stripe 2 of the stored value (Gift) card 400.

This information includes, inter alia, identification of the stored value (Gift) card issuer and account number along with the stored value (Gift) card expiration date. Further definition of magnetic stripe encoding may be found in ANSI X4.16-1983 “American National Standard for Financial Services—Financial Transaction Cards—Magnetic Stripe Encoding”.

The microprocessor on the docking module control assembly 203 checks the stored value (Gift) card 400 number and expiration date on track two of the stored value (Gift) card. The expiration date is checked against the network date of the attached cellular telephone 100. The microprocessor on the docking module control assembly 203 conducts a Luhn validation of the stored value (Gift) card number to determine if the stored value (Gift) card has been altered or forged.

If the microprocessor on the docking module control assembly 203 determines that the expiration date has expired or the phone card is not valid, it prints out on the thermal docket printer 213 a brief report advising that the stored value (Gift) card has expired or is invalid.

If the microprocessor on the docking module control assembly 203 determines that the stored value (Gift) card is valid and is not expired, then the microprocessor on the docking module control assembly 203 displays a message on the attached cellular telephone's 101 screen advising the retailer to key in the amount to be credited to the account of this stored value (Gift) card. The microprocessor on the docking module control assembly 203 then prompts the retailer for their enabling PIN number.

Upon acceptance of the PIN number from the retailer, the microprocessor on the docking module control assembly 203, utilizing the incorporated multifunction security access module (SAM) 204 to encrypt the transaction (stored value (Gift) card number, PIN, etc) prior to invoking a dialing routine with the attached cellular telephone 100. The cellular telephone 100 dials the pre-configured number of the registration computer 318. The registration computer 318 further validates the stored value (Gift) card through a validation or verification computer system in the stored value (Gift) card issuer's premises or some such recognized stored value (Gift) card clearing facility. Upon verification, which takes about 7 to 15 seconds, a response is returned to the microprocessor on the docking module control assembly 203, via the attached cellular telephone 100, that the transaction has been accepted.

With the transaction being accepted, the microprocessor on the docking module control assembly 203 instructs the thermal docket printer 213 to print a detailed duplicate slip as a record of the transaction, the original is kept by the retailer, with the duplicate copy for the customer to keep, and display a ‘Transaction Completed’ message on the screen of the attached cellular telephone 100.

It will be understood that certain features and subcombinations are of utility and may be employed without reference to other features and subcombinations as they are outlined within the description above and within the claims appended hereto. While the preferred embodiments and application of the invention have been described, it is apparent to those skilled in the art that the objects and features of the present invention are only limited as set forth in the claims appended hereto.

1. A secure point-of-sale cellular telephone docking module system comprising:
a cellular telephone including an auxiliary connector;
a docking module having a docking module connector to electrically connect with said auxiliary connector;
said docking module further including a microprocessor;
said docking module further including at least one magnetic media reading device in electrical communication with said microprocessor;
said docking module further including a printing device in electrical communication with said microprocessor;
said docking module further including a multifunctional security access integrated circuit in electrical communication with said microprocessor; and
said docking module further including an electrical power source for said microprocessor, said magnetic media reading device, said multifunctional security access module and said printing device.

2. The secure point-of-sale cellular telephone docking module system of claim 1 wherein said magnetic media reading device is a magnetic strip card reader.

3. The secure point-of-sale cellular telephone docking module system of claim 1 wherein said magnetic media reading device is a magnetic ink character reader.

4. The secure point-of-sale cellular telephone docking module system of claim 1 wherein said printing device is a thermal docket printer.

5. The secure point-of-sale cellular telephone docking module system of claim 1 wherein said printing device is an Axiohm model CHTP-9024 thermal printer.

6. The secure point-of-sale cellular telephone docking module system of claim 1 wherein said microprocessor is a Motorola MC68HC711 microprocessor.
